(19) United States
(12) Patent Application Publication
(10) Pub. No.: US 2005/0146705 A1
(43) Pub. Date: Jul. 7, 2005

(54) Range accuracy compensation circuit for single-shot laser rangefinders

(76) Inventors: Jonathan S. Lei, Springfield, VA (US); Bradley W. Schilling, Fredericksburg, VA (US); Dallas N. Barr, Woodbridge, VA (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/743,766

(22) Filed: Dec. 24, 2003

(51) Int. Cl. G01C 3/08

(52) U.S. Cl. 356/5.01; 356/4.01

(57) ABSTRACT

An improvement in a single-shot laser rangefinder having a photo-detector for detecting return laser pulse signals, a signal amplifier for amplifying the return laser pulse signals, and a range processor for determining the range of a reflecting object from the round trip time of flight of the return laser pulse signals. The difference in time at which the strongest laser pulse signal crosses the threshold for detection and the weakest laser pulse signal crosses the threshold for detection causes a timing error in the measured range. The improvement includes a plurality of comparators whose inputs are connected to the signal amplifier, each comparator outputting a digital level signal in response to an analog input signal that is more than the threshold set therein at the negative input terminal of the comparator; a plurality of latches, each latch connected to a respective comparator, the comparator outputs being fetched to the clock inputs of the latches so that when the digital level signal presents itself at the clock input, the latch then latches to the digital level signal; and a microcontroller having a plurality of inputs, each input connected to a respective latch for reading the outputs from the latches, the microcontroller having a store containing a plurality of pre-set correction factors corresponding to the range errors for various pulse amplitudes, the microcontroller having an output connected to the range processor for outputting the compensated range to the range processor upon decoding the output signals of the latches.

### BACKGROUND OF THE INVENTION

This invention relates in general to rangefinders, and more particularly, to laser rangefinders.

Conventional single-shot laser rangefinders operate by emitting a very short, high power, laser pulse, and detecting the reflected light. The amplitude of the reflected light pulse can be large or small depending upon the distance to the target and other factors such as atmospheric conditions or the target's reflectivity. The range is calculated from the round trip time of flight (TOF) of the laser pulse, using the speed of light. Historically, laser range-finding has been achieved using laser pulses with extremely fast rise times, on the order of 1 or 2 nanoseconds. Due to the nature of some recent, solid-state laser technologies, particularly in the eye-safe wavelength of 1.5 μm, laser pulses with rise times on the order of 10-15 ns are being developed and applied to laser range-finding. Long rise-time laser pulses make it more difficult to achieve the very high range accuracy demanded by many military applications, (±1 m or less).

The rangefinder accuracy problem arises from the fact that under differing circumstances, such as target reflectivity or atmospheric attenuation, the return laser pulses have widely varying amplitudes. The situation is shown in FIG. 1 for three such pulses having peak amplitude of 1.0 mV, 10 mV, and 100 mV. As the graph shows, these Gaussian shaped pulses have different amplitudes, but the same pulse width of about 18 ns (FWHM). For the simulation, pulses with a dynamic range of 100:1 are shown. For some systems, however, the return pulses can have a dynamic range in the order of 1000:1 (i.e. 1 V to 1 mV), so in that sense, this analysis is conservative.

To investigate the accuracy problem in detail, assume that the threshold for detection is set to 1.0 mV, labeled as Vₜ₂ in FIG. 1, such that the smallest pulse shown is just detected. The difference in time at which the strongest pulse crosses the threshold and the weakest pulse crosses the threshold, shown as t₂ in FIG. 1, is the timing error in question. For the pulses shown, the error in timing between a strong pulse and a weak pulse is about 22 ns. Of course, light travels at 3.0×10⁸ m/s, therefore 22 ns corresponds to (22×10⁻⁹ s)×(3.0×10⁸ m/s)=6.6 meters. Since the range measurement is a round trip measurement, this timing error corresponds to a 6.6÷2=3.3 meter range error. Note that a medium amplitude pulse, like the 10 mV pulse shown in FIG. 1, reaches the detector t₁ seconds later than the strongest pulse. Reading the timing error from the graph shown in FIG. 1, t₁ is about 7 ns, corresponding to about 1 meter of range error. To summarize, using a simple threshold detection, a Gaussian laser pulse with a FWHM pulse width of 18 ns, and with a dynamic range of 100:1 (due to target or various atmospheric conditions), a ranging error of up to 3.3 meters is inherent in the system due to this phenomenon. Notice that this error occurs even before any range processing.

### SUMMARY OF THE INVENTION

It is therefore an object of this invention to solve the rangefinder accuracy problem.

This and other objects of the invention are achieved by providing a range accuracy compensation means in the single shot laser rangefinder. The compensation means is connected between the photo-detector and the range processor. It determines, within a certain error band, the amplitude of the return laser pulse. Assuming the basic pulse shape is known a priori, the amplitude information is then used to add a corrective factor to the measured range and thereby improve the range accuracy of the rangefinder. To clarify, assume that the rangefinder receives a return pulse equal to one of the three pulses in FIG. 1. If the rangefinder can determine which of these pulses was received, an appropriate corrective factor can be added to the measured result and the rangefinder's overall range accuracy will be improved. For the smallest pulse shown in FIG. 1, for example, the correction would be to subtract t₂ from the measured time-of-flight (TOF), or Actual TOF=(Measured TOF)−t₂. Note that even though an infinite number of pulse amplitudes are possible, it is only necessary to determine if the received pulse falls within one of a few “bands” of similar pulses to achieve ±1 meter accuracy.

Additional advantages and features will become apparent as the subject invention becomes better understood by reference to the following detailed description when considered in conjunction with the accompanying drawings wherein:

### BRIEF DESCRIPTION OF THE DRAWINGS

FIG. 1 shows Gaussian pulses to demonstrate the rangefinder accuracy problem.

FIG. 2 is a block diagram of a laser rangefinder incorporating the range accuracy compensation circuit in accordance with the invention.

FIG. 3 shows Gaussian pulses to demonstrate solution of the rangefinder accuracy problem.

### DETAILED DESCRIPTION

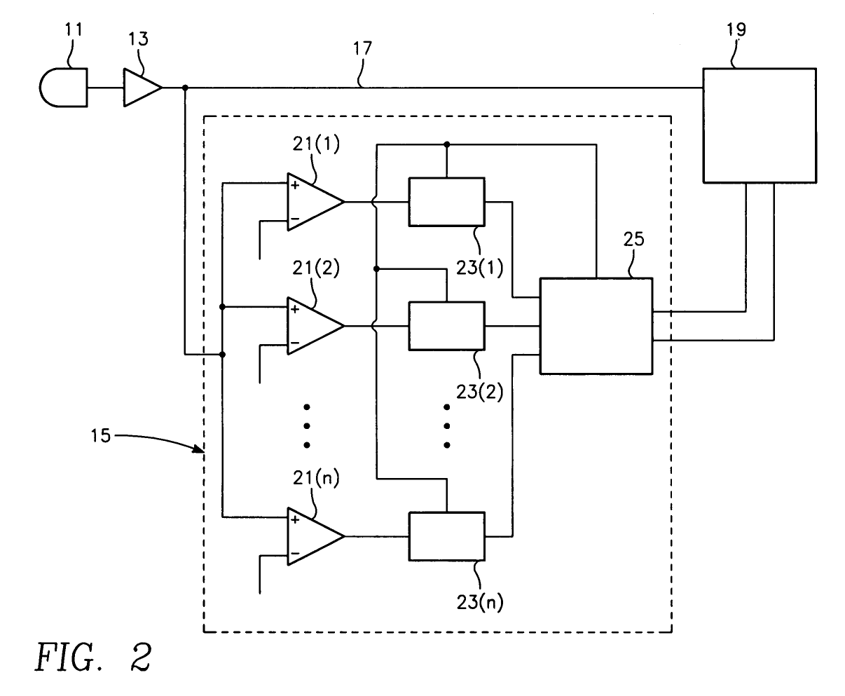

Referring to FIG. 2, there is schematically illustrated a single shot laser rangefinder incorporating the range accuracy compensation means of the present invention. Since such rangefinders are known in the rangefinder arts it will be described only insofar as necessary to set forth the cooperative relationship of the present invention. Laser pulses are reflected by a target upon being illuminated by a laser (not shown), and the return signals are detected by a photo-detector 11 and amplified in a signal amplifier 13. The amplified signals are applied via the range accuracy compensation means 15 of the present invention and a lead 17 to a range processor 19 where the range is calculated from the round trip of flight of the laser pulses, using the speed of light. The calculated range may then be displayed on a display (not shown). Since the present invention is deemed to reside in the range accuracy compensation means 15, further description of the other elements of the rangefinder, which are well known to those skilled in the art, is considered superfluous.

As shown in FIG. 2, the range accuracy compensation means in the dotted box 15 may include a plurality of comparators 21(1)-21(n) providing threshold detection of the multiple voltage levels arriving at the photo-detector 11. Each comparator 21(1)-21(n) supplies a digital level signal in response to an analog input signal that is more than the threshold level set therein at the negative-input terminal of the comparator. The comparator outputs are then fetched to the clock inputs of the latches 23(1)-23(n). Thus, when the signal presents itself at the clock input, the latch then latches to the digital level signal for the microcontroller 25 to read at a later time. The microcontroller 25 has a store containing a plurality of pre-set correction factors corresponding to the range errors for various pulse amplitudes. This correction table is determined via experimentation and test and stored prior to ranging operations. Upon decoding the output signals of the latches 23(1)-23(n), the microcontroller 25 then outputs the compensated range to the range processor 19.

In a preferred embodiment, prior to each ranging, a reset pulse from the rangefinder circuitry is fed to the microcontroller 25 serving as a buffer to clear all the latches 23(1)-23(n). Then, when a return pulse arrives at the photo-detector 11, the pulse is amplified and is fed to the comparator inputs. Each comparator 21(1)-21(n) is provided with a pre-selected threshold level.

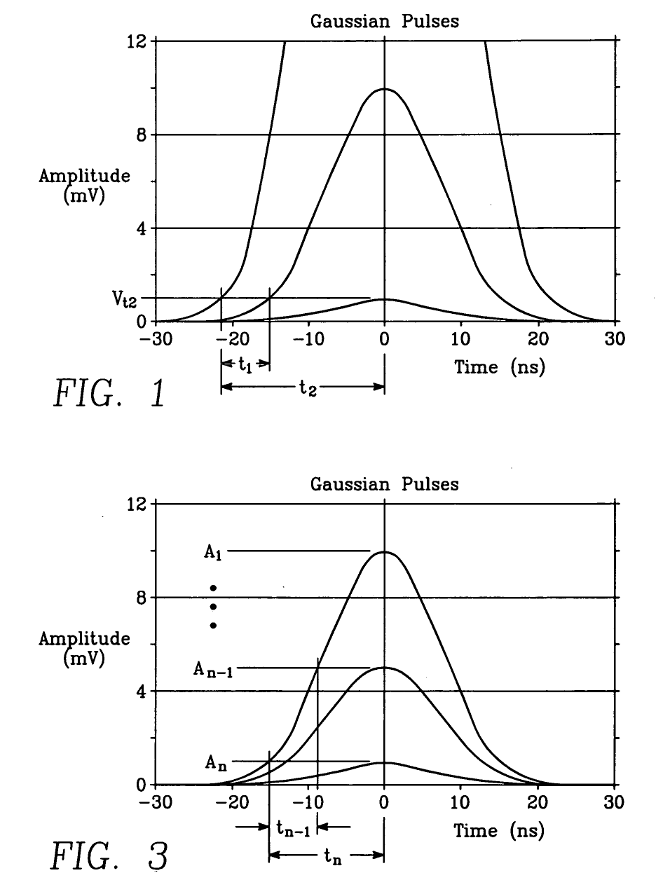

FIG. 3 may be used to help explain the concept. FIG. 3 is identical to FIG. 1, but for clarity, doesn't try to show a 100:1 dynamic range of amplitudes. Referring, therefore to FIG. 2 and FIG. 3, comparator 21(1) is selected to have a threshold level of A₁, comparator 21(2)) is selected to have a threshold level of A₂, and comparator 21(n) is selected to have a Aₙ threshold level. In this embodiment, if the amplitude of the return pulse has a voltage level of A₁ or more, each output of comparators 21(1)-21(n) is set to a digital high level, since the return pulse amplitude is greater than or equal to each of the comparator threshold voltages. In this case, no compensation range is required to subtract from a measured range.

Next, consider a second case. Assume that the amplitude of the return pulse is just above Aₙ (the lowest threshold voltage of the set of comparators). In this embodiment, comparators 21(1)-21(n-1) output a digital low level, since the return pulse amplitude is below the thresholds of each of these comparators. Comparator 21(n), however, will output a digital high level signal. The comparator output signals are latched and read by the microcontroller 25. The microcontroller 25 reads the latch outputs, starting from latch 23(1) to latch 23(n). Upon finding the first high level signal at the output of a particular latch, the range compensation is sent to the range processor and display circuits 19. So in this particular case, a timing correction factor of tₙ is provided by the microcontroller 25 and applied to the final result. To sum up, when a return pulse crosses threshold voltage Aₓ, (1≦x≦n), but not that of threshold voltage Aₓ₋₁, a timing correction factor of tₓ is applied to the final TOF result. This process is continued for as many threshold levels as is necessary to achieve the desired accuracy.

The invention described herein addresses a common problem inherent in single-shot laser rangefinders having relatively slow rise-time laser pulses. The simple and low-cost solution taught will improve the range accuracy of such devices to within the desired levels.

It is obvious that many modifications and variations of the present invention are possible in light of the above teachings. It is therefore to be understood that within the scope of the appended claims, the invention may be practiced otherwise than as described.

1. In a single-shot laser rangefinder having a photo-detector for detecting return laser pulse signals, and a range processor for determining the range of a reflecting object from the round trip time of flight of the return laser pulse signals, the difference in time at which the strongest laser pulse signal crosses the threshold for detection and the weakest laser pulse signal crosses the threshold for detection causing a timing error in the measured range,
range accuracy compensation means connected between the photo-detector and the range processor for determining within a certain error band the amplitude of a return laser pulse and for using the amplitude information to add a corrective factor to the measured range.

2. The rangefinder recited in claim 1 wherein the range accuracy compensation means is connected to the photo-detector by way of a signal amplifier.

3. The rangefinder recited in claim 1 wherein the range accuracy compensation means includes:
a plurality of comparators whose inputs are connected to the photo-detector to provide threshold detection of multiple voltage levels arising at the photo-detector.

4. The rangefinder recited in claim 3 wherein each comparator outputs a digital level signal in response to an analog input signal that is more than a threshold set therein at the negative input terminal of the comparator.

5. The rangefinder recited in claim 4 wherein the range accuracy compensation means includes:
a plurality of latches, each latch connected to a respective comparator, the comparator outputs being fetched to the clock inputs of the latches so that when the digital level signal presents itself at the clock input, the latch then latches to the digital level signal.

6. The rangefinder recited in claim 5 wherein the range accuracy compensation means includes:
a microcontroller having a plurality of inputs, each input connected to a respective latch for reading the outputs from the latches.

7. The rangefinder recited in claim 6 wherein the microcontroller has a store containing a plurality of pre-set correction factors corresponding to the range errors for various pulse amplitudes.

8. The rangefinder recited in claim 7 wherein the microcontroller has an output connected to the range processor, and the microcontroller outputs the compensated range to the range processor upon decoding the output signals of the latches.

9. In a single-shot laser rangefinder having a photo-detector for detecting return laser pulse signals, a signal amplifier for amplifying the return laser pulse signals, and a range processor for determining the range of a reflecting object from the round trip time of flight of the return laser pulse signals, the difference in time at which the strongest laser pulse signal crosses the threshold for detection and the weakest laser pulse signal crosses the threshold for detection causing a timing error in the measured range,
a plurality of comparators whose inputs are connected to the signal amplifier to provide threshold detection of multiple voltage levels arising at the photo-detector, each comparator outputting a digital level signal in reference to an analog input signal that is more than a threshold set therein at the negative input terminal of the comparator;
a plurality of latches, each latch connected to a respective comparator, the comparator outputs being fetched to the clock inputs of the latches so that when the digital level signal presents itself at the clock input, the latch then latches to the digital level signal; and
a microcontroller having a plurality of inputs, each input connected to a respective latch for reading the outputs from the latches, the microcontroller having a store containing a plurality of pre-set correction factors corresponding to the range errors for various pulse amplitudes, the microcontroller having an output connected to the range processor for outputting the compensated range to the range processor upon decoding the output signals of the latches.

10. A method of compensating for range accuracy comprising the steps of:
(a) receiving return laser pulse signals;
(b) determining the range of a reflecting object from the round trip time of flight of the return laser pulse signals, the difference in time at which the strongest laser pulse signal crosses the threshold for detection and the weakest laser pulse signal crosses the threshold for detection causing a timing error in the measured range;
(c) determining within a certain error band the amplitude of a return laser pulse; and
(d) using the amplitude information to add a corrective factor to the measured range.

11. The method recited in claim 10 wherein step (a) includes:
photo-detecting return laser pulse signals.

12. The method recited in claim 11 wherein step (a) includes:
amplifying the return laser signals.

13. The method recited in claim 10 wherein step (b) includes:
processing the amplified return signals in a range processor.

14. The method recited in claim 10 wherein step (c) includes:
feeding the return laser pulse signals to a plurality of comparators, each comparator outputting a digital level signal in response to an analog input signal that is more than a threshold set therein at the negative input terminal of the comparator.

15. The method recited in claim 14 wherein step (c) includes:
fetching the comparator outputs to the clock inputs of a plurality of latches so that when the digital level signal is presented at the clock input, the latch latches to the digital level signal.

16. The method recited in claim 15 wherein step (d) includes:
reading the outputs from the latches into a microcontroller having a store containing a plurality of pre-set correction factors corresponding to the range errors for various pulse amplitudes.

17. The method recited in claim 16 wherein step (d) includes:
decoding the output signals of the latches.

18. The method recited in claim 17 wherein step (d) includes:
outputting the compensated range to the range processor.
